(19) United States
(12) Patent Application Publication
(10) Pub. No.: US 2014/0257830 A1
(43) Pub. Date: Sep. 11, 2014

(54) VERIFICATION PROCESSING FOR BROKERED ENGAGEMENTS

(71) Applicant: AMERICAN WELL CORPORATION, Boston, MA (US)

(72) Inventor: Roy Schoenberg, Boston, MA (US)

(73) Assignee: AMERICAN WELL CORPORATION, Boston, MA (US)

(21) Appl. No.: 13/792,503

(22) Filed: Mar. 11, 2013

(51) Int. Cl. G06Q 30/00; G06Q 50/22

(52) U.S. Cl. CPC G06Q 30/016; G06Q 50/22
USPC 705/2

(57) ABSTRACT

Described are techniques for providing broker services to consumers and service providers. The techniques include verification of consumer eligibility to consult with a service provider and techniques for determining a consumer's level of access and co-pays.

### BACKGROUND

The present disclosure is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider. These types of services have been broadly referred to as “e-visits.”

Other health care solutions include technologically advanced telephone communication solutions that use advances in voice communication and data transmission technology to interconnect medical professionals with patients. For instance, a professional association contracts with providers capable of providing the necessary services to consumers. Consumers call a toll-free number to request a consultation with a provider. The request is processed after the consumer hangs up the telephone and the consumer waits for a return phone call. Another example is a brokerage type system as described in my issued U.S. Pat. No. 7,590,550, which is incorporated herein by reference.

### SUMMARY

According to an aspect, a computer-implemented method includes receiving from a consumer device a request to consult with a service provider, the request including consumer personal information, plan sponsor information, and a plan identification, determining eligibility of a consumer associated with the request, to engage in the consultation under a service plan corresponding to the plan identification, and while determining eligibility, determining by one or more computers a service provider to engage in a real-time consultation with the consumer, receiving eligibility information that indicates the consumer's eligibility and level of access to services and co-pays required by the plan, adding by the one or more computers an entry corresponding to the consumer to a queue maintained for the service provider; and when the entry corresponding to the consumer in the queue is at the top of the queue, causing by the one or more computers establishment of a real-time communication channel between a device used by the provider and the device used by the consumer.

According to an aspect, a computer program product tangibly stored on a computer readable storage device for providing broker services to consumers and service providers, the computer program product comprising instructions for causing a computer to receive from a consumer device a request to consult with a service provider, the request including consumer personal information, plan sponsor information, and a plan identification, determine eligibility of a consumer associated with the request, to engage in the consultation under a service plan corresponding to the plan identification; and while determining eligibility, determine a service provider to engage in a real-time consultation with the consumer, receive eligibility information that indicates the consumer's eligibility and level of access to services and co-pays required by the plan, add an entry corresponding to the consumer to a queue maintained for the service provider, and when the entry corresponding to the consumer in the queue is at the top of the queue, cause establishment of a real-time communication channel between a device used by the provider and the device used by the consumer.

According to an additional aspect, an apparatus includes a processor, memory in communication with the processor, and a computer program product stored on a computer readable medium for providing broker services to consumers and service providers, the computer program product comprising instructions for causing the processor to receive from a consumer device a request to consult with a service provider, the request including consumer personal information, plan sponsor information, and a plan identification, determine eligibility of a consumer associated with the request, to engage in the consultation under a service plan corresponding to the plan identification; and while determining eligibility, determine a service provider to engage in a real-time consultation with the consumer, receive eligibility information that indicates the consumer's eligibility and level of access to services and co-pays required by the plan, add an entry corresponding to the consumer to a queue maintained for the service provider, and when the entry corresponding to the consumer in the queue is at the top of the queue, cause establishment of a real-time communication channel between a device used by the provider and the device used by the consumer.

The following are some of the features within the scope of the above aspects. Determining eligibility includes determining by the one or more computer systems that the consumer is affiliated with the plan by using augmenting features to speed up processing by the one or more computers of requests without having to wait for remote databases of plan administrators to respond to verification requests. Determining eligibility includes sending by the one or more computer systems the consumer information to a remote system; and receiving by the one or more computer systems consumer eligibility information. Consumer eligibility information comprises a current listing of services sponsored by the plan sponsor. Determining eligibility includes determining by the one or more computer systems that the consumer is affiliated with the plan by detecting that the client device is on a plan sponsor network, or that the request is an e-mail having a plan sponsor domain address or that by using global positioning data that the device is within the plan sponsor's facility. Determining a service provider includes determining a suitable service provider to engage in a real-time consultation with the consumer based on matching of service provider attributes with consumer specified criteria. The engagement is a telephonic-based communication, and with the one or more computers initiating a call-back as the real time communication by, sending by the one or more computers a telephone number of the consumer to the service provider to have the service provider initiate the call-back between the service provider and the consumer. The engagement is a telephonic-based communication, and the one or more computers execute an interactive voice recognition process, the consumer personal information and plan sponsor information in the request from the consumer. Establishing a web based channel as the real time communication. The consumer device is a computer based device that receives from a graphical user interface sent to the computer based device, the consumer personal information and plan sponsor information, and with the request further including medical information for use during a consultation.

One or more of the following advantages may be provided by one or more of the above aspects.

Consumers can request a consultation with a provider and the system will process the request to find a service provider, etc. as the consumer's eligibility is being determined. By providing real time verification of eligibility and sponsor ahead of coming into the consultation provides a more efficient and satisfying consultation experience. The verification process can minimize use of remote databases of health plan or broker that works with health plan to verify sponsor affiliation and covered services. The verification can use technological characteristics of the consumer's device to provide indications of coverage such as by detecting that the device is being used within a client facility that is a sponsor of a health plan using data from the client device such as an internet protocol (IP) address or a global positioning signal (GPS), etc. Thus this approach can minimize frustration when an immediate consultation is desired, by greatly minimizing consumers' waiting time to engage with s provider.

### BRIEF DESCRIPTION OF THE FIGURES

FIG. 1 is a diagrammatic view of a telephonic-based engagement brokerage system.

FIG. 2 is a flow chart useful in understanding verification processing.

FIG. 3 is block diagram of availability processing.

FIG. 4 is a block diagram of a record.

FIGS. 4A and 4B are block diagrams of queue structures.

FIGS. 5, 6, 7A, and 7B are screenshots of graphical user interfaces.

### DETAILED DESCRIPTION

Overview

The system described below provides an integrated information and communication platform that enables consumers of services to access service providers to consult and to carry out such consultations in an efficient manner. Part of this efficiency involves a particular verification of eligibility processing to identify eligibility for particular services. In the system, consumers are able to consult with an expert service provider even when the two parties are geographically separated. This integrated platform can be a telephonic-based or web based brokerage system (or service).

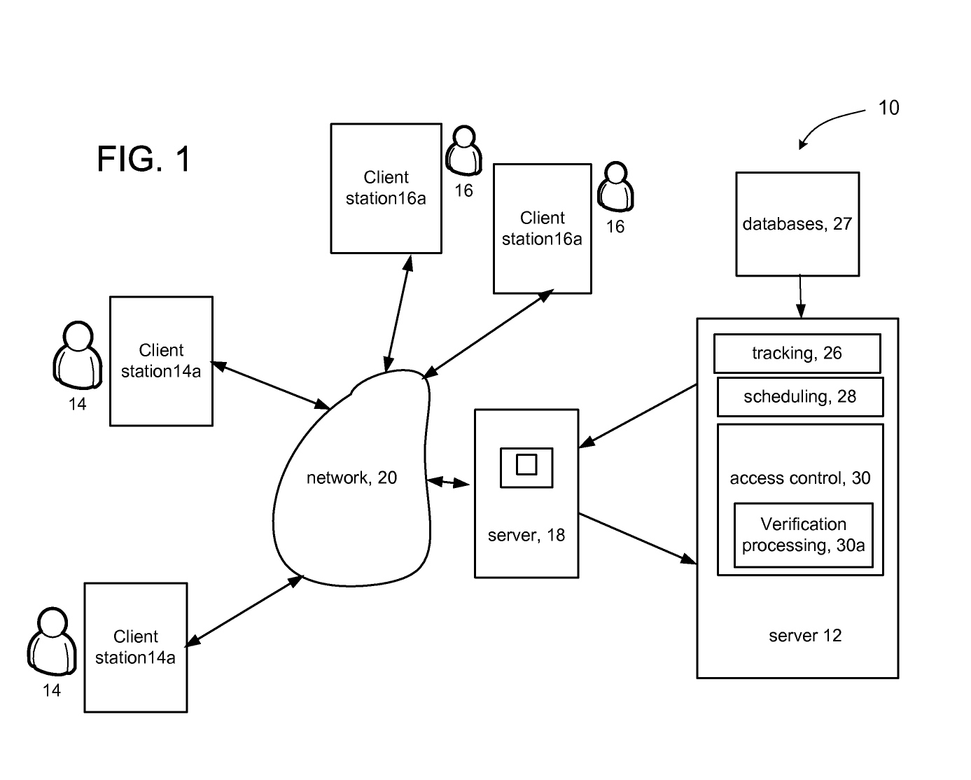

Referring now to FIG. 1, an exemplary networked computer system 10 that includes telephonic-based engagement brokerage functionality includes a computerized system or server 12 for processing telephonic requests from consumers 14 at client systems 14a to engage with providers 16 at provider systems 16a. In some aspects, the networked computer system 10 implements a brokerage service embodied as a telephonic-based engagement brokerage. In other aspects, the networked computer system 10 implements a brokerage service embodied as web-based engagement brokerage. The networked computer system 10 during telephonic-based engagement brokerage provides information to service providers 16 at client systems 16a, over a network 20, e.g., a telephonic network that can be a switched network and/or that can include the Internet (e.g., voice over IP (VOIP)). In other implementations, the networked computer system 10 includes a web server 18 to receive on-line web-based requests and which provides web-based communication channels over the Internet between a provider and a consumer using a web browser or the like.

The server 18 receives a request for a consultation either via a telephone call or via a graphical user interface or the like. The request is parsed to identify the particular ailment or concern, etc. of the patient 14. This parsing can be done automatically such as through an interactive voice response system using either speech recognition or a keypad-based menu system, or manually by the consumer engaging with a customer service representative (CSR) for telephonic requests or via information obtain though the user interface for web-based requests.

The server 12 includes an availability or presence tracking module 26 for tracking the availability of the service providers 16. Availability or presence is tracked actively or passively. In an active system, one or more of the service providers 16 provides an indication to the server 12 that the one or more service providers are available to be contacted by consumers 14 and an indication of the mode by which the provider may be contacted. In some examples of an active system, the provider's computer, phone, or other terminal device periodically provides an indication of the provider's availability (e.g., available, online, idle, busy) to the server 12 and a mode (e.g., text, voice, video, etc.) by which he can be engaged.

In a passive system, the server 12 presumes that the service provider 16 is available by the service provider's actions, including connecting to the server 12 or registering the provider's local phone number with the system. In some examples of a passive system, the server 12 indicates the provider 16 to be available at all times until the provider logs off, except when the provider is actively engaged with a consumer 14.

The server 12 also includes one or more processes in addition to the tracking module 26, such as a scheduling module 28. The server 12 accesses one or more databases 27. The components of the server 12 and the web server 18 may be integrated or distributed in various combinations as is commonly known in the art.

The networked computer system 10 allows a consumer 14 to communicate with a provider 16. In some embodiments, such as a telephonic call-back engagement, the server 12 will send to the provider sufficient information to allow the provider to call back the consumer. In other embodiments, the consumer 14 and provider 16 connect to the server 12 through a telephonic switch or a website or other interface on the web server 18 using client devices 14a and 16a, respectively. Client devices 14a and 16a can be any combination of, e.g., personal digital assistants, land-line telephones, cell phones, computer systems, media-player-type devices, and so forth. The client devices 14a and 16a enable the consumers 14 to input and receive information as well as to communicate via video, audio, and/or text with the providers 16.

Limited by office hours and other patients, providers struggle with the idea of adding another service commitment to their existing workload. Patients sending queries to their providers cannot expect an immediate response and are often asked to schedule an appointment for further evaluation. Providers are, however, often available at times that are not convenient for their patients, for example, in the event of a last-minute cancellation. Providers also may be available for e-visits during otherwise idle times; such as when home, during their commute, and so forth. The brokerage supplements existing provider availability to allow whichever providers are available at any given time to engage consumers for the other types of engagements mentioned above. Instead of relying on the unlikely availability of a specific provider for any given consumer, the brokerage finds for the consumer currently available providers capable of addressing the consumer's needs.

One advantage that the brokerage provides is that the brokerage constantly monitors the availability of a provider for an engagement. Thus, consumers receive relatively quick attention to address their questions or concerns. When engaging via telephone with call-back, the server 12 forwards the patient connection information to currently available service providers allowing those service providers to call-back the consumer. When engaging via a web browser or the like, the server 12 can cause a communication channel to be established between the consumer and the provider. The server 12 identifies service providers 16 that are available at any given moment to communicate with a consumer about a particular product, service, or related topic or subject, for example, a medical condition. The server 12 facilitates establishment of communication directly by provider 16 with the consumer 14, enabling them to communicate, for example, via telephonic or video or voice communication channel (such as Voice over IP), land and mobile telephone network channels, and instant messaging or chat.

In order to achieve such a level of availability, the networked computer system 10 assimilates the discretionary or fractional availability windows of time offered by individual providers at stations 16a into a continuous availability perception by consumers. Consumers will have little expectation that the same provider will be constantly available, rather, they expect that some provider will be available.

The availability of one or more providers 16 is tracked. In callback examples, when a consumer 14 desires communicate with a provider, a request is processed through intake and the server 12 determines a currently available provider for a call back. In non-callback examples, at the instant a consumer 14 desires to connect and communicate with a provider, the server 12 determines whether that provider is available. If that particular provider 16 is available, the server 12 assesses the various modes of communication that are available forwards connection information of the consumer 14 to the service provider 16 through one or more common modes of communication. The system selects a mode of communication to use based in part on the relative utility of the various modes.

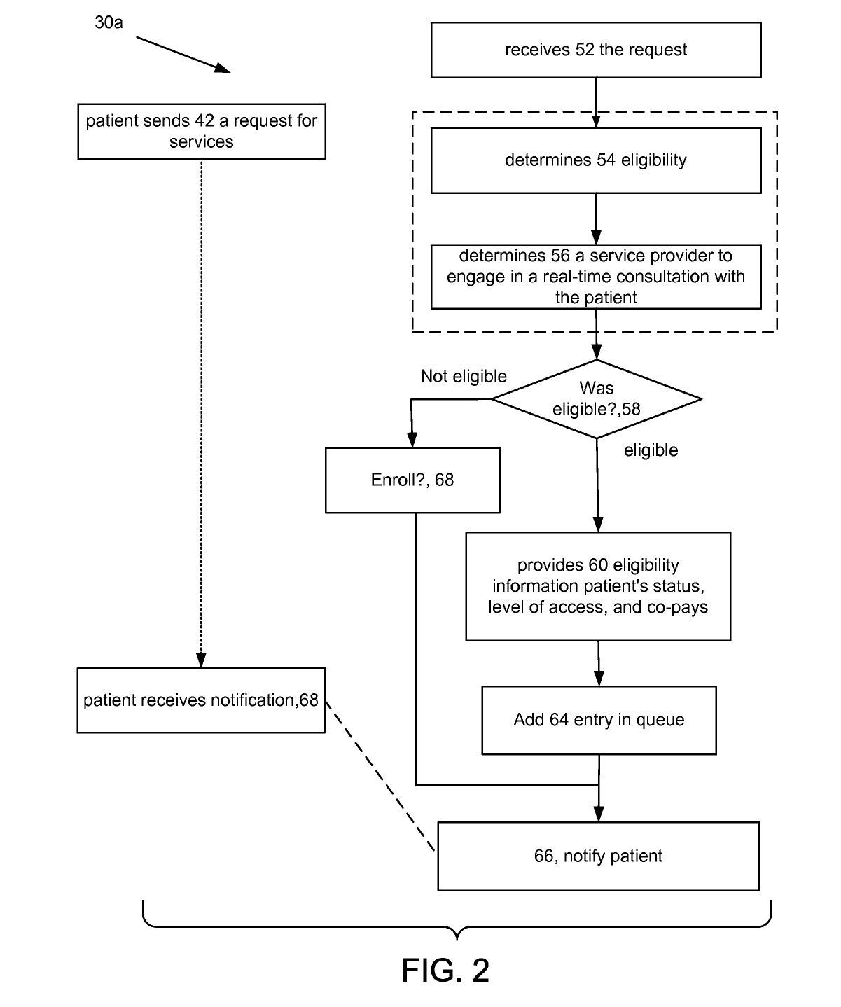

A mode for a non-callback engagement has both the consumer 14 and the provider 16 use web-based consoles, as this allows each of the other modes to be used as needed. For example, consumers and providers may launch chat sessions, voice calls, or video chats from within a web-based console like that shown in FIG. 2A, below. A web based console also provides on-demand access to records, such as the consumer's medical history, and other information. If only one of the participants in an engagement has access to a web console, the server 12 connects that participant's console to whatever form of communication the other party has available. For example, if the consumer is on the phone and the provider is using a web browser, the server 12 may connect the consumer's phone call to a VoIP session that the provider can access through the web. If the provider 16 is not available, the server 12 identifies other available providers 16 that would meet the consumer 14's needs. The server 12 enables the consumer 14 to send a message to the consumer's chosen provider.

The server 12 includes an access control facility 30 that manages and controls whether a particular consumer 14 can access the networked computer system 10 and what level or scope of access to the features, functions, and services the networked computer system 10 will provide. The access control 30 includes verification processing 30a that verifies eligibility of a particular consumer to access and to the level of service.

By way of illustration, the networked computer system 10 services patients that are members of healthcare plans. For example, the service providers 16 may be physicians, and the service consumers 14 may be patients. The service providers and service consumers may also be lawyers and clients, contractors and homeowners, or any other combination of a provider of services and a consumer of services.

The system enables the consumer to search for providers that are available at the time the consumer is searching, and enables the consumer to engage a provider on a transactional basis or for a one-time consultation. A consumer can use the system for various purposes, such as a consultation or second opinion.

An example of an Interactive Voice Response (IVR) system is discussed in U.S. Pat. No. 7,590,550 entitled: “Connecting Consumers with Service Providers”, the contents of which are incorporated herein in its entirety. As noted, a consumer can access the IVR system via a telephone and the server 12 parses responses into a formulation of the consumer's inquiry either by keypad entries or speech recognition technologies.

Referring now to FIG. 2, an example of verification processing 30a for use in the networked computer system 10 is shown. In an embodiment, a patient sends 42 a request for services to the networked computer system 10 either via a telephone call or a graphical user interface (web-based). The server 12 while receiving 52 the request to consult with a service provider, determines 54 the patient's eligibility for services.

The request includes consumer personal information, plan sponsor information, and plan identification. The server 12 determines 54 eligibility of the consumer to engage in the consultation under the plan corresponding to the plan identification; and while determining eligibility, the server 12 also determines 56 a service provider to engage in a real-time consultation with the consumer. When the server 12 determined 58 that the consumer was eligible, 54, the server retrieves and thus provides 60 the eligibility information for the consumer, e.g., eligibility status, level of access to services, and co-pays, etc. required by the plan.

If the consumer was determined as eligible, the server adds 64 an entry corresponding to the consumer to a queue maintained for a service provider provided by the server 12 as part of processing to determine a service provider. This information stored in the queue will include pointers to data involving medical conditions entered by the consumer, and determined eligibility information for the consumer's eligibility status, level of access to services, and co-pays required by the plan. The server 12 can notify 66 the consumer of the level of service eligibility status, level of access to services, and co-pays required by the plan.

If the consumer is not eligible the server can ask the consumer to enroll 68 or take other action. If the consumer who is not eligible desires to enroll, the server 12 either in conjunction with a CSR (customer service representative) for a telephonic engagement or automatically for a web-based engagement, causes the patient to enroll in an online-care program offered by the system.

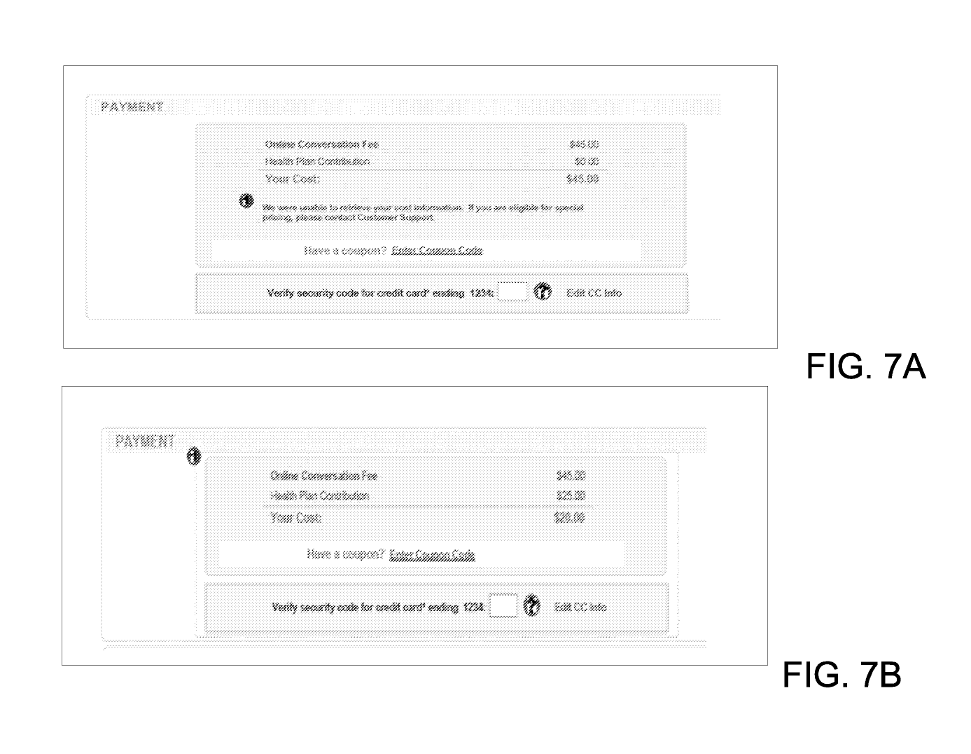

In either event the server communicates relevant information to the consumer, e.g., eligibility status co-pays, etc. as set out in FIGS. 7A, 7B.

In either event, when the entry corresponding to that consumer in the queue is at the top of the queue, the server will cause the establishment of a real-time communication channel with a device used by the consumer.

Either the CRS (for telephonic) or the system 12 (for telephonic or web based) or the patient (using an automated IVR system) finds a suitable service provider by merely determining a specialty that would be suitable for the patient and a provider that is currently available or can involve more in-depth processing such as determining a list of suitable service providers by matching attributes of service providers to metrics provided by the consumer, which define a suitable service provider that meets the consumer's preferences. In this situation, the server receives a selection one of the suitable service providers from the consumer.

Determining eligibility can include queries to remote databases such as of the plan administrator or can involve other techniques such as determining by the server 12 that the consumer is affiliated with the plan by detecting a location of a client device, e.g., client station 14a being within a facility controlled by the plan sponsor. For example detecting a client device being within a facility controlled by the plan sponsor can involve detecting that the client device is on a plan sponsor network, or that the request is an e-mail having a plan sponsor domain address or that by using global positioning data that the device is within the plan sponsor's facility. By using these augmenting features it could significantly speed up processing by the brokerage system of requests without having to wait for remote databases of plan administrators to respond to verification requests. In some instances, queries to remote databases of plan administrators can be eliminated or otherwise minimized. In other instances, queries to remote databases of plan administrators would be required. Whether the augmentation would be effective would depend on several factors. Among those factors would include the availability of information regarding the plan sponsor's facility, domains, etc. and the location of the consumer device. In addition, the freshness of the information stored by the brokerage on the specific plans and the plan sponsors would be another factor. Other factors are possible.

When determining eligibility by sending the consumer information to a remote system, the eligibility information is subsequently received by the server 12. The consumer eligibility information includes a current listing of services sponsored by the plan sponsor and an indication of what of those services the patient is currently eligible for. The server 12 conveys the eligibility information to the patient. When the engagement is telephonic-based the server initiates a call-back as a real time communication by sending a telephone number of the patient to the service provider to have the service provider initiate the call-back and can include the information of the services that the patient is eligible for. When the engagement is web-based the server 12 establishes a real time communication channel and conveys the eligibility information. In addition to consumer personal information and plan sponsor information, the request typically also includes some medical information for use during the consultation.

From the provider's viewpoint, the provider chooses a patient from a virtual waiting room (queues discussed below). The virtual waiting room can include not only phone based patients but other patients such as patients that have accessed a portion of the server 12 that is involved with real time consultations that are initialed on line rather than telephonically.

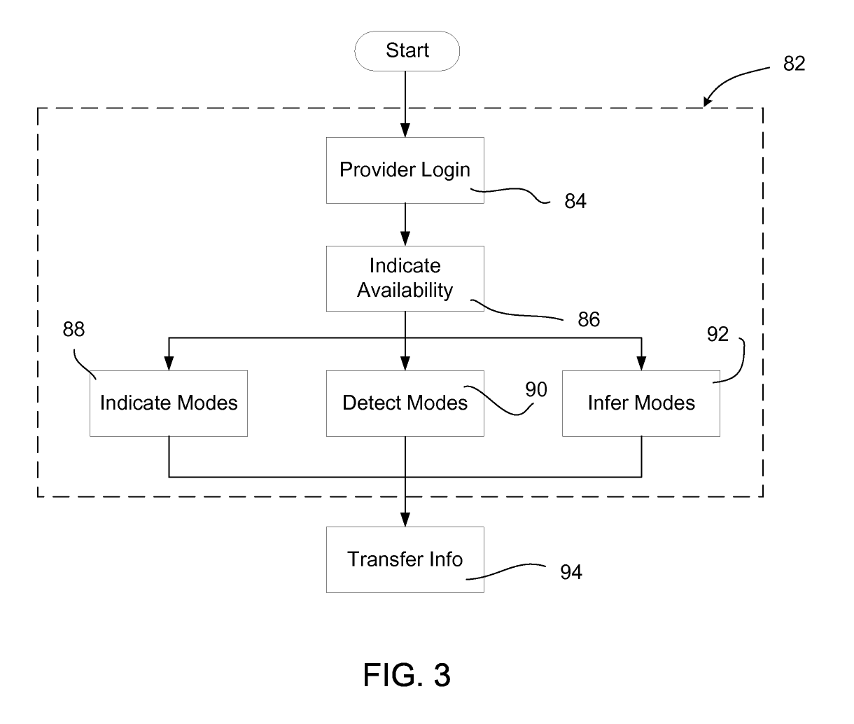

Referring now to FIG. 3, the server 12 tracks 82 the availability of providers 16 and in some embodiments, on-line consumers 14. When a provider 16 logs 84 into the networked computer system 10, the provider 16 indicates 86 (such as by setting a check box or selecting a menu entry or by responding to a voice prompt) to the tracking module 26 that he or she is available to interact with consumers 14. The provider 16 can also indicate 88 to the tracking module 26 (such as by setting a check box or selecting a menu entry or by responding to a voice prompt) the modes (e.g., telephone, chat, video conference) by which a consumer 14 can be connected to the provider 16.

Alternatively, in non-callback modes, the tracking module 30 determines 90 the capabilities of the terminals 14a and 16a the consumer 14 and the provider 16 use to connect to the system (for example, by using a terminal-based program to analyze the hardware configuration of each terminal). Thus, if a provider 16 connects to the networked computer system 10 by a desktop computer and the provider has a video camera connected to that computer, the tracking module 26 determines 90 that the provider 16 can be engaged by text (e.g., chat or instant messenger), voice (e.g., VoIP) or video conference. Similarly, if a provider 16 connects to the system using a handheld device such as a PDA, the tracking module 26 determines 92 that the provider 16 can be engaged by text or voice, whereas, if the consumer connects to the networked computer system 10 via a telephone for a telephonic engagement the provider will reply with a telephone call to the consumer. The tracking module 26 can also infer 92 a provider's availability and modes of engagement by the provider's previously provided profile information and the terminal device through which the provider connects to the system.

Providers participating in the brokerage network can have several states of availability over time. States in which the provider may be available include “on-line”, in which the provider is logged-in and can immediately accept new engagements in any mode, “on-line (busy)”, in which the provider is logged-in but is currently occupied in another engagement, and “scheduled”, in which the provider is offline but is scheduled to be online at a designated time-point and can pre-schedule engagements for it.

While not online, the provider can take messages as in offline state. Thus, another state includes off-line, in which the provider is not logged in but can take message-based engagements (i.e., asynchronous engagements), out-of-office, in which the provider is not accepting engagements or messages, and “on call”, in which the provider is offline and can be paged to go to on-line status by the brokerage network if traffic load demands it (in some examples, consumers see this state as offline).

The operating business model for the provider network employs a remuneration scheme for providers that helps assure that the consumers can find providers in designated professional domains in the online mode. For example, selected providers can be remunerated for being in the on-call mode to encourage on-line availability in case of low discretionary availability by other providers in their professional domain. On-call providers are also called into the on-line state when the fraction of on-line (busy) provider's domain exceeds a certain threshold.

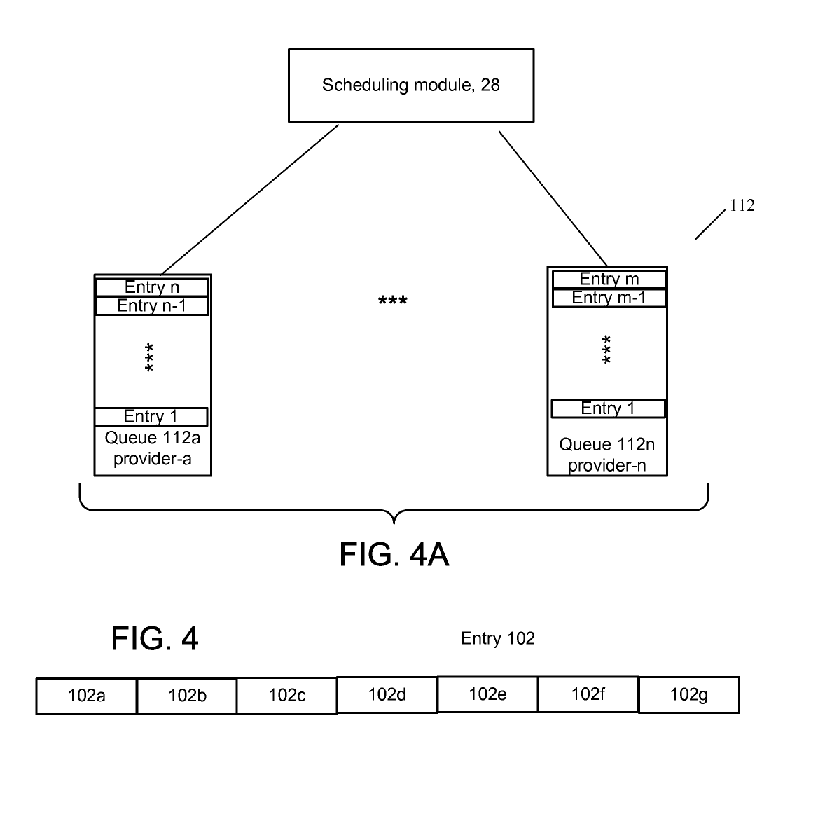

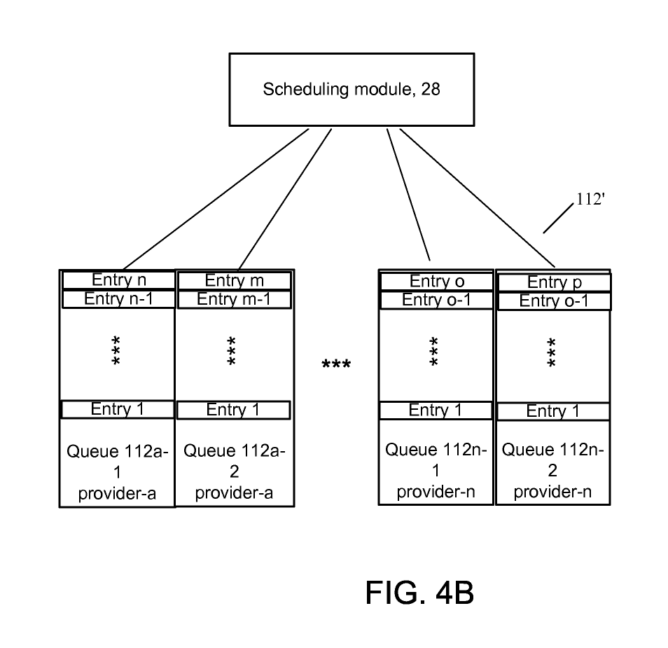

Referring now to FIG. 4, an exemplary depiction of records 102 that are retrieved by the server 12 for an entry in queues (FIGS. 4A and 4B) is shown. Entries are the requisite information or pointers to records with the requisite information, or otherwise cause records 102 to be produced, e.g., by queries to databases 27. Records 102 includes various fields such as personal identification information, 102a, plan information 102b, connection information 102c, time stamps 102d, level of access to services 102e, co-pays required by the plan 102f, and pointers 102g to medical information that may be useful during the consultation such as information previously entered by the patient. Other information can also be included. In addition, other configurations can also be employed such as having the queues hold these records as entries in the queues.

Referring now to FIG. 4A, the tracking module 26 (FIG. 1) transfers 94 (FIG. 4) information about the availability and the communication capabilities of the consumers 14 and the providers 16 to the scheduling module 28. The scheduling module 28 uses the tracking information to schedule providers with consumers. In one scheduling algorithm, each provider is associated with a queue, e.g., 112a-112n. The queue for each provider is filled by the server 12 with entries (as depicted as entries n and entries m) that represent consumers that desire to have consultations with a provider. More specifically, as consumers access the networked computer system 10 and are processed through the intake process, entries representing the consumers are produced by the server 12 and those entries are queued.

In one embodiment, the server 12 stores the entries in queues of those providers that the server determines has the least number of entries, in order to balance provider utilization across the system 10, and to otherwise minimize overall response time for consumers. The server 12 will use a first in first out priority scheme to retrieve records from the query in order to furnish information to providers for servicing clients such as through call-backs.

Thus, in a telephonic engagement, as described above, after intake processing (or alternatively before intake processing has been completed) the server 12 produces an entry for storage in one of the queues (generally 112). The server 12 examines the queues 112a-112n of all providers that are suitable to provide a consultation with the consumer and the server chooses the queue of a suitable provider that has the least number of entries waiting to be processed. The queue, e.g., queue 112a of the chosen provider (provider-a) is loaded with that entry. A telephonic call-back engagement can be either one that is a scheduled engagement where the server 12 provides a time for the call-back based on when each of the consumer and provider are available or a non-scheduled call-back based on the available provider.

In servicing consumer requests, for a particular provider, the server 12 retrieves the entry of a consumer that is next to be serviced (generally the oldest entry in the queue 112). As the provider services that consumer, the server 12 removes the corresponding entry from that provider's queue and then the server 12 promotes all remaining entries in that queue such that the next entry in the queue to be serviced will be now be the oldest entry.

Referring now to FIG. 4B, in an alternative embodiment, the queues (generally 112′) for each provider are sub-divided or represented as plural sub-queues with each of the sub-queues corresponding to an appointment “state.” In FIG. 4B, two queues 112a-1 to 112a-2 and 112n-1 to 112n-2 are shown for each of the providers, e.g., “provider a” to “provider n” with the sub-queues 112a-1 to 112a-2 and 112n-1 to 112n-2 representing, “waiting room” and “scheduled appointments” of the respective providers “provider a” to “provider n.”

In this embodiment, the server using scheduling module 28, examines the queues of all providers that are suitable to provide a consultation with the consumer and chooses the appropriate sub-queue of a suitable provider that has the least number of entries waiting to be processed for the particular state, e.g., “waiting room” and “scheduled appointments.” More specifically, for “telephonic engagements” the server loads entries into the waiting room queue of the particular provider that has the fewest entries.

In servicing requests, for a particular provider, the system retrieves the entry of a consumer that is next to be serviced from the waiting room for that provider. The next to be serviced is according to the following priority the oldest entry in the waiting room, unless the server determines that the scheduled appointment queue of the provider has either an entry for a scheduled telephonic callback or scheduled appointment that has an scheduled appointment time that is either equal to the current time or would be within a time window where the servicing of a waiting room entry or a new request would adversely impact servicing of scheduled telephonic callback or scheduled appointment queued entries. For example, in some embodiments the system 10 could allocate a set time period of, e.g., 15 minutes to service a request. Accordingly, the server 12 would not select an entry from the waiting room queue if there was a scheduled appointment in, e.g., 10 minutes. Telephonic engagements without any prior scheduling will generally be placed in and thus serviced from the waiting room sub-queue. As the provider services a consumer from its sub-queue all remaining entries (representing other consumers) in that sub-queue are promoted such that the next entry in the sub-queue to be serviced will be the next oldest entry. In another embodiment, the server 12 stores all incoming telephonic call-back engagements in a waiting room queue along with other types of engagements. One queue is used for all providers and the scheduling module 28 examines the queue and chooses the provider that is next available.

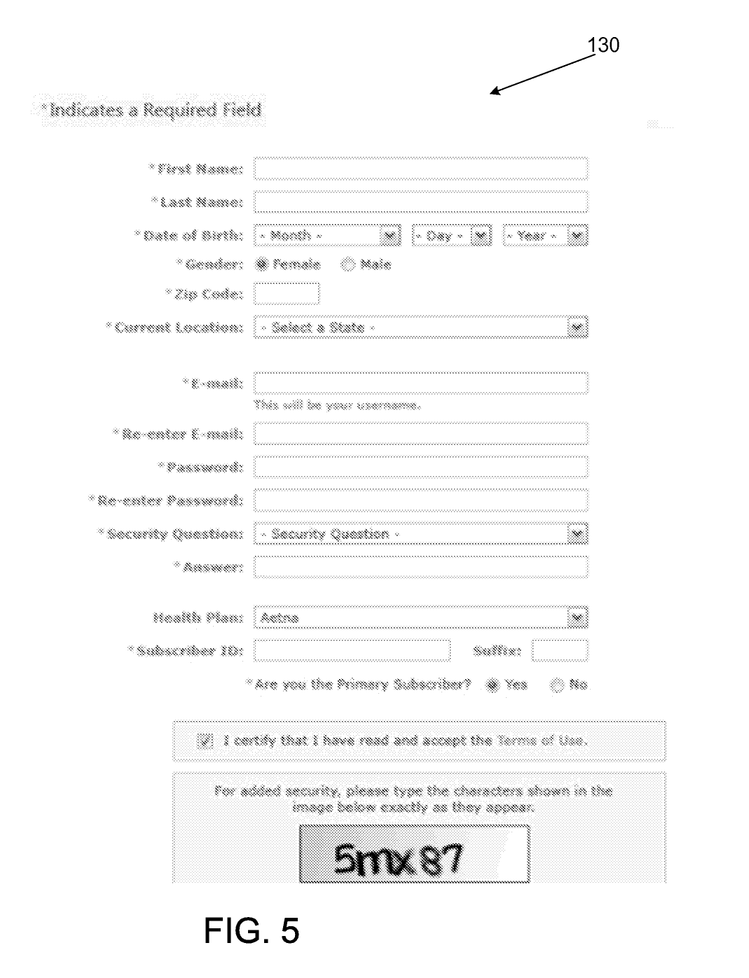

Referring now to FIG. 5, a typical request screen 130 (for web requests) is shown. A consumer is presented with the interface 130 to allow the consumer to provide information regarding the consumer to the server. The screen 130 requires personal identification information, e.g., name, e-mail, etc. as well as a challenge, and also requires health plan carrier and subscriber number or other similar information.

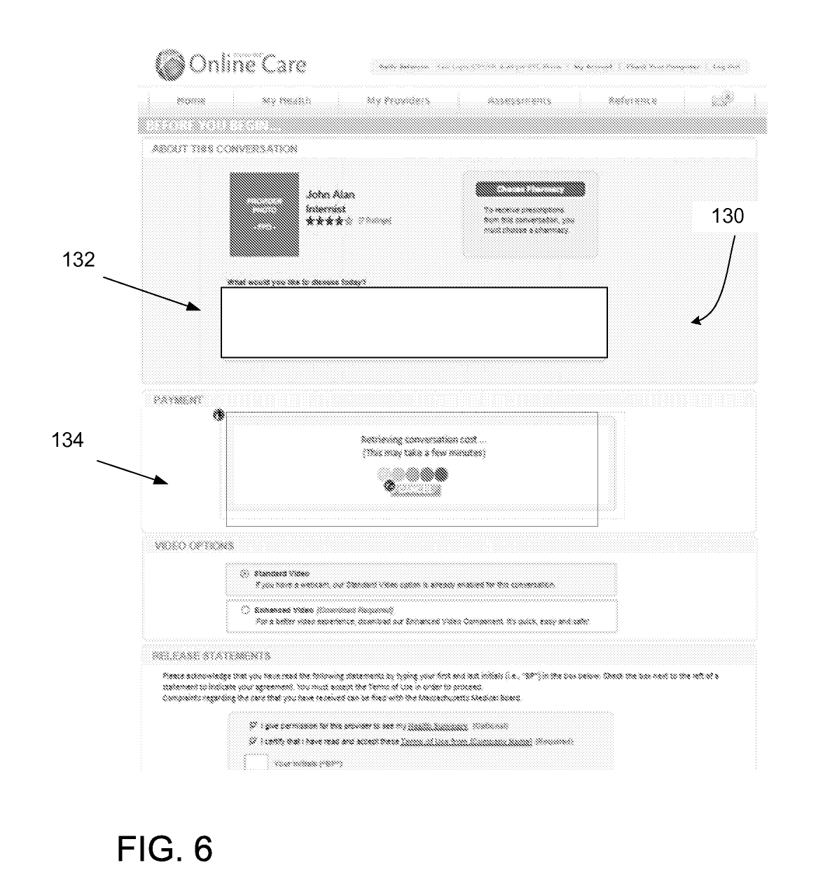

Referring now to FIG. 6, the consumer receives in return a graphical user interface 130 that lists the service representative (not referenced) a field 132 for inserting answers to questions (there can be many questions) and a region 134 that presents the consumer's eligibility information such as co-pays and level of service and payment, shown as in process. The system can provide other screens to the consumer and the provider to enable them to connect as shown in my issued patent.

Referring now to FIGS. 7A, 7B, the payment portion of the interface of FIG. 6 is shown with the server 12 sending to the consumer a list the consumer's cost and eligibility status information. FIG. 7A shows a typical situation where there is an issue with eligibility status. The payment portion can include several messages such as shown to contact customer support, or a message with a link to a profile page “MyProfile” for the consumer to verify entered information. The payment portion otherwise lists the cost to the consumer and has a link for a coupon code and various security measures for a credit card. FIG. 7B shows a typical situation where there are no eligibility status issues and otherwise lists the cost to the consumer in this case $20.00. There could be other co-pay amounts including no cost to the consumer and has a link for a coupon code and various security measures for a credit card. The actual cost of the conversation fee would be governed by the terms of the insurance plan etc. that covered the engagement. Each of these interfaces can also include the above fields (FIG. 6).

As noted, the server 12 includes access control facilities 30 that control how consumers 14 access the system and to what extent or level the services provided by the system are made available to consumers. The server 12 also stores and provides access to consumer information (e.g., contact information, credit and financial information, credit card information, health information, and other information related to the consumer and the services purchased or otherwise used by the consumer) and provider information (e.g., physician biographies, product and service information, health related content and information and any information the provider or the health plan wants to make available to members) and the access control facility 30 can prevent unauthorized access to this information. In some examples, the server 12 exports the consumer information for use in a provider's office or other facility.

In some implementations of the networked computer system 10 consumers access the either on-line and/or through the telephonic engagements discussed above. In other implementations, of the brokerage system 10 access is only through telephonic engagements. In this later instance, the queue structures can be greatly simplified. Several types of engagements may exist, e.g., “consumer-initiated engagements” “follow-up engagements” and “prescheduled engagements” and “standby engagements.”

In some embodiments, consumers may select providers according to attributes of the provider, such as a geographical area where the provider is located or which professional organizations have accredited the provider (e.g., whether a doctor has board certification in cardiology). Any metrics within the provider profile can be used to define a list of providers that meet the consumer's preferences. In this case, the system will use the consumer's selection to override the least used scheme for populating provider queues.

Modes of Engagement

Telephonic Callbacks

Consumers who wish for a telephonic consultation with a provider may use a traditional telephone to enter information, as discussed above, and hangs up and waits for a call-back from a suitable provider, as also discussed above. Providers are sent information concerning the consumer in order to understand the consumer's issue and a telephone number by which the provider contacts the consumer.

In some embodiments of the networked computer system 10, the networked computer system 10 allows consumers to engage provider's e.g., health professionals “on demand” based on provider availability. These engagements can be established in various ways as described in the above mentioned patent. These types of engagements include:

Passive Browsing

Reference health content is accessed on the brokerage's website. The website can support the use of licensed content packages from other vendors to meet the variable preferences of health plans. For example, key content vendors include Healthwise™, ADAM™, Mayo Clinic™ and HealthDay™. Content libraries provided by such vendors offer a combination of articles, imagery, interactive tutorials and related tools that allow consumers to access content relevant for their health issues. Many health plans and major employers already possess a license for the use of one of these content packages.

Health Risk Assessments

The system acquires information from consumers through automated interaction (e.g., rules-based interaction) in order to crystallize their needs (e.g., medical risks) and better direct them. Assessments span from general health to very specific medical conditions and follow a path of questioning that dynamically tailors itself based on information already retrieved (e.g., using predefined rules). As assessments progress, the system constructs engagement suggestions that the consumer can exercise. Each suggestion represents both the question to the provider and the type of provider appropriate to answer it. Consumers may choose to simply launch such engagements or apply their own discretion as to the phrasing and the selection of the recipient provider. This is discussed in more detail below in the context of the consumer advisor.

Asynchronous Correspondence

The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).

Synchronous Correspondence

Several forms of synchronous correspondence allow the consumer and the provider to engage in real-time discussions.

Synchronous Text Correspondence

This may be referred to as a “Chat” module where both sides of the engagement type their entries in response to each others' entries. The form of communication may be entirely text based but is still a live communication. Examples include instant messaging and SMS messaging.

Web-Based Teleconferencing

The use of broadband network connections allows for real-time voice transmission over the Internet in what is referred to as full duplex (i.e., both voice channels are open at the same time). Consumers can opt to have a voice conversation with their providers using, for example, their computer's speakers and microphone. Web-based teleconferencing may use VoIP, SIP, and other standard or proprietary technologies.

Telephonic Conferencing

Consumers who wish for a direct telephonic communication with a provider or who are not comfortable using their computer may use a traditional telephone for interaction with a provider. The consumer may use a dial-in number and an access code that connects him to the brokerage's servers. Providers are linked to the servers via VoIP, other data-network-based voice systems, or their own telephones. Telephonic conferencing may also allow consumers to request “call me now” functions, in which the provider calls the consumer (directly or through the brokerage).

Video Conferencing

The system can support video conferencing to allow consumers to exhibit physical findings to providers if such disclosure is needed. Consumers and providers may also simply prefer face-to-face communication, even if remote. Small digital cameras, referred to as webcams, attached to or built in to personal computers or laptops can be used for this purpose. Video conferencing can be provided by standard software or by custom software provided by the brokerage. Alternatively, dedicated video conferencing communication equipment or telephones with built-in video capabilities can be used.

Semi Synchronous Correspondence

Some engagements of a consumer with an online provider include both synchronous and asynchronous interactions. Part of the engagement takes place by immediate messaging between the two, but the provider may ask the consumer to take occasional asynchronous assessments if, for example, a generic line of question is desired. This allows the provider to operate more than one consumer engagement at a time while each consumer is constantly engaged. For example, semi-synchronous correspondence includes a combination of e-mail, instant messaging, test messaging, voice calls and mail messaging, and VoIP calls and VoIP messaging.

Interactive Voice Response Engagements

Interactive Voice Response (IVR) systems allow for the deployment of interactive audio menus over the phone. The caller can navigate between options, listen to data-driven information, provide meaningful input, and engage system functions. IVR engagements extend the reach of the system to the telephone as a portable consumer interface to launch an engagement in addition to the Web-based interface. Consumers select a pin code on the application to authenticate their identity if they call in. Several types of engagements can be carried out through an IVR system using suitable logic such as described in the patent. For dial-in engagements, the consumer calls in and invokes a telephonic engagement with an available provider. The IVR system extends the consumer's ability to select a provider to the phone so that the consumer's interaction resembles one carried out on the Web.

The IVR system can also be used proactively to pursue consumers who need a follow-up. At the time of a follow-up, the system recalls the provider with whom the follow-up is desired (or the type of provider in case the follow-up is not restricted to a specific provider), identifies that the provider is available for an engagement, and attempts to contact the consumer over the phone to establish a connection for the engagement. Once contacted, the consumer can decline or ask postpone the call. If the consumer takes the call, the connection is made. When consumers are pursuing an engagement with a provider that is either busy or currently offline, the IVR system allows the consumer to park in a standby mode until the provider is available. When the provider is available, the system calls the consumer, identifies the provider to the consumer, and verifies that the consumer is still interested in pursuing the call with the provider. If the consumer is still interested, an engagement is connected.

In addition to launching engagements, the IVR interface allows consumers to interact with other services offered by the brokerage. For example, consumers can instruct the system to fax a transcript of their information to a fax machine that the consumer identifies by keying in or speaking its phone number. Using such a function, a consumer makes key information available to, e.g., emergency room personnel or to a provider in an office visit, without the need to plan, collect, print, and carry the information to that encounter. IVR hardware is readily available from telecommunication vendors and can be programmed to operate in the context of the brokerage framework. Authentication is provided through a PIN number or by other standard methods.

The consumer information collected by the intake process may be stored in the databases 27 as part of the overall brokerage. In some examples, the consumer information is protected and secured from unauthorized access and in compliance with the various legal requirements for storing private consumer information (for example, HIPPA governs access to an individual's health care information). The database 27 may also the process logic and rules data including the business logic of an application or rules for a rules engine that implements the consumer advisor module.

The brokerage extends the result of any engagement to a physical point of care or service provider to allow continuation or escalation of services beyond those provided in the electronic encounter.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving from a consumer device a request to consult with a service provider, the request including consumer personal information, plan sponsor information, and a plan identification;
determining eligibility of a consumer associated with the request, to engage in the consultation under a service plan corresponding to the plan identification; and while determining eligibility,
determining by one or more computer systems a service provider to engage in a real-time consultation with the consumer;
receiving eligibility information that indicates the consumer's eligibility and level of access to services and co-pays required by the plan;
adding by the one or more computer systems an entry corresponding to the consumer to a queue maintained for the service provider; and when the entry corresponding to the consumer in the queue is at the top of the queue,
causing by the one or more computer systems establishment of a real-time communication channel between a device used by the provider and the device used by the consumer.

2. The method of claim 1, wherein determining eligibility comprises:
determining by the one or more computer systems that the consumer is affiliated with the plan by using augmenting features to speed up processing by the one or more computers of requests without having to wait for remote databases of plan administrators to respond to verification requests.

3. The method of claim 1, wherein determining eligibility comprises:
sending by the one or more computer systems the consumer information to a remote system; and
receiving by the one or more computer systems consumer eligibility information.

4. The method of claim 3, wherein consumer eligibility information comprises a current listing of services sponsored by the plan sponsor.

5. The method of claim 1, wherein determining eligibility comprises:
determining by the one or more computer systems that the consumer is affiliated with the plan by detecting that the client device is on a plan sponsor network, or that the request is an e-mail having a plan sponsor domain address or that by using global positioning data that the device is within the plan sponsor's facility.

6. The method of claim 1, wherein determining by one or more computers a service provider comprises: determining a suitable service provider to engage in a real-time consultation with the consumer based on matching of service provider attributes with consumer specified criteria.

7. The method of claim 1, wherein the engagement is a telephonic-based communication, and the method further comprises:
initiating by the one or more computers a call-back as the real time communication by, sending by the one or more computers a telephone number of the consumer to the service provider to have the service provider initiate the call-back between the service provider and the consumer.

8. The method of claim 1, wherein the engagement is a telephonic-based communication, and the method further comprises:
receiving by the one or more computers executing an interactive voice recognition process, the consumer personal information and plan sponsor information in the request from the consumer.

9. The method of claim 1, wherein the engagement is a web-based communication, and the method further comprises:
establishing by the one or more computers a web based channel as the real time communication.

10. The method of claim 9, wherein the consumer device is a computer based device, the method further comprising:
receiving by the one or more computers from a graphical user interface sent to the computer based device, the consumer personal information and plan sponsor information, and with the request further including medical information for use during a consultation.

11. A computer program product tangibly stored on a computer readable storage device for providing broker services to consumers and service providers, the computer program product comprising instructions for causing a computer to:
receive from a consumer device a request to consult with a service provider, the request including consumer personal information, plan sponsor information, and a plan identification;
determine eligibility of a consumer associated with the request, to engage in the consultation under a service plan corresponding to the plan identification; and while determining eligibility,
determine a service provider to engage in a real-time consultation with the consumer;
receive eligibility information that indicates the consumer's eligibility and level of access to services and co-pays required by the plan;
add an entry corresponding to the consumer to a queue maintained for the service provider; and when the entry corresponding to the consumer in the queue is at the top of the queue,
cause establishment of a real-time communication channel between a device used by the provider and the device used by the consumer.

12. The product of claim 11, further comprises instructions to:
determine that the consumer is affiliated with the plan by detecting that the client device is on a plan sponsor network, or that the request is an e-mail having a plan sponsor domain address or that by using global positioning data that the device is within the plan sponsor's facility.

13. The product of claim 11, further comprises instructions to:
send the consumer information to a remote system; and
receive by the one or more systems consumer eligibility information.

14. The product of claim 11 wherein consumer eligibility information comprises a current listing of services sponsored by the plan sponsor.

15. The product of claim 11, further comprises instructions to:
determine a suitable service provider to engage in a real-time consultation with the consumer based on matching of service provider attributes with consumer specified criteria.

16. An apparatus comprising:
a processor;
memory in communication with the processor; and
a computer program product stored on a computer readable medium for providing broker services to consumers and service providers, the computer program product comprising instructions for causing the processor to:
receive from a consumer device a request to consult with a service provider, the request including consumer personal information, plan sponsor information, and a plan identification;
determine eligibility of a consumer associated with the request, to engage in the consultation under a service plan corresponding to the plan identification; and while determining eligibility,
determine a service provider to engage in a real-time consultation with the consumer;
receive eligibility information that indicates the consumer's eligibility and level of access to services and co-pays required by the plan;
add an entry corresponding to the consumer to a queue maintained for the service provider; and when the entry corresponding to the consumer in the queue is at the top of the queue,
cause establishment of a real-time communication channel between a device used by the provider and the device used by the consumer.

17. The apparatus of claim 16, further comprises instructions to:
determine that the consumer is affiliated with the plan by detecting that the client device is on a plan sponsor network, or that the request is an e-mail having a plan sponsor domain address or that by using global positioning data that the device is within the plan sponsor's facility.

18. The apparatus of claim 16, further comprises instructions to:
send the consumer information to a remote system; and
receive by the one or more systems consumer eligibility information.

19. The apparatus of claim 16, further comprise instructions to:
determine that the consumer is affiliated with the plan by using augmenting features to speed up processing by the one or more computers of requests without having to wait for remote databases of plan administrators to respond to verification requests.

20. The apparatus of claim 19, wherein instructions to determine a suitable service provider further comprise instructions to:
determine the suitable service provider based on matching of service provider attributes with consumer specified criteria.
